(19) United States
(12) Patent Application Publication
(10) Pub. No.: US 2026/0307187 A1
(43) Pub. Date: Oct. 8, 2026

(54) Machining center, particularly for workpieces pieces to be machined such as beams, boards, or similar

(71) Applicant: Essetre S.r.l. Unipersonale, Thiene (VI) (IT)

(72) Inventor: Enrico Pasquale, Grumolo delle Abbadesse (Vicenza) (IT)

(21) Appl. No.: 19/482,404

(22) PCT Filed: May 3, 2024
(86) PCT No.: PCT/IB2024/054287

§ 371 Date: Nov. 7, 2025

(30) Foreign Application Priority Data
May 12, 2023 (IT) 102023000009570

(51) Int. Cl. B23Q 1/01; B23Q 1/48

(52) U.S. Cl. CPC B23Q 1/012; B23Q 1/4866

(57) ABSTRACT

A machining center includes a portal having an opening for receiving a piece to be machined; supply members for the piece to be machined, with a rectilinear supply path; and a working unit having an electrospindle for coupling to and operating a work tool, supported by first and second linear translation members for translating perpendicularly to the supply direction and rotatable around axes perpendicular to each other. The working unit is carried by a third linear translation member, interposed between the working unit and the first and second linear translation member and rotatable respective to the first and second translation members around perpendicular axes, and with a translation direction of the working unit that is perpendicular to a rotation axis of the third translation member, the translation direction of the third translation member being parallel to a rotation axis of the working unit.

The present invention relates to a machining center, particularly for pieces to be machined such as beams, boards, or the like, which includes:
a portal, optionally of the stationary type, presenting a passage opening for a piece to be machined, such as a beam to be machined, or the like;
supply members for said piece to be machined, along a straight supply path of said piece to be machined, which path is oriented according to a first axis of translation (X) and insertion of said piece through said passage opening;
a working unit comprising an electrospindle for coupling and operating at least one working tool;
said working unit being supported by first and second linear translation members of the same according to at least a first and a second direction of translation, respectively, which first and second directions of translation are perpendicular to said supply direction and being also rotatable around at least two rotation axes perpendicular to each other.

Machining centers of this type are known in the state of the art, for example, but not limited to document IT102011901997732.

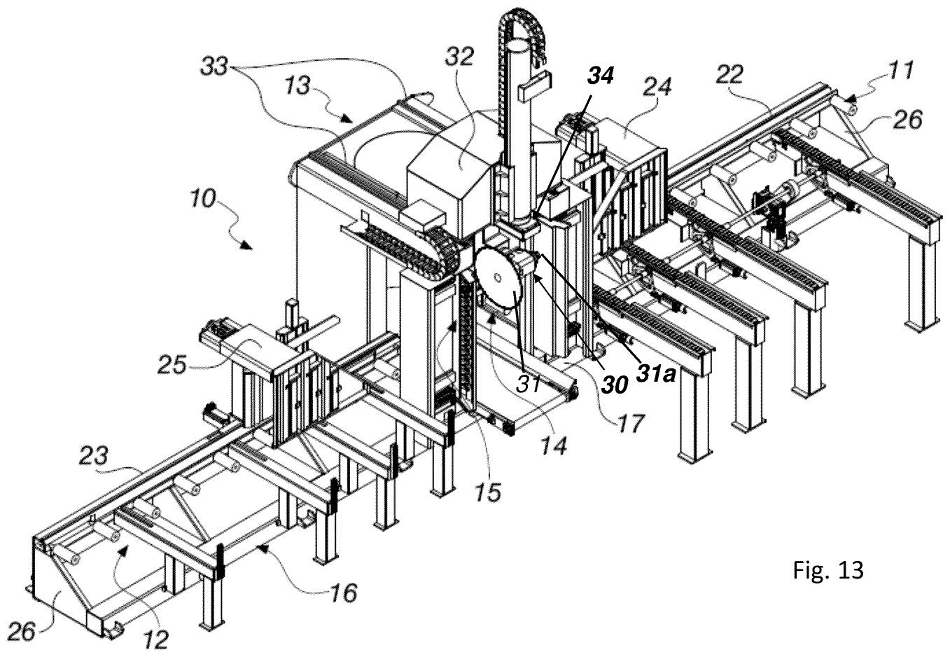

In particular, and only by way of example and not limitation, FIG. 13 shows a machining center according to the known art and as described above. The machining center exemplified in FIG. 13 is a so-called fixed portal machining center for machining wooden beams and is globally indicated with 10. Such a machining center 10 comprises a loading conveyor 11, an unloading conveyor 12, and a central frame 13 carrying the working unit 14, and the corresponding tool magazine 15. In this exemplary but not limiting embodiment, the loading and unloading conveyors 11 and 12 and the central frame 13 are pre-assembled to define a single-block base 16.

In the embodiment described here, to be considered exemplary and not limiting of the invention, the single-block base 16 features a longitudinal structural element 17, horizontal, to which the loading conveyors 11 and unloading conveyor 12 and the central frame 13 are fixed. This longitudinal structural element 17 is given, for example, by a tubular profile in metal material. The loading and unloading conveyors are provided in combination with guides 22 and 23 for corresponding loading 24 and unloading 25 clamps. The loading and unloading conveyors 11 and 12 are oriented to advance the piece to be machined or a succession of pieces to be machined in a first x translation direction for supplying said pieces or parts of said pieces inside the machining station in the central frame 13, i.e., the fixed machining portal. Conveyors 11 and 12 interrupt at the central frame 13, which is also frontally fixed with front mounting elements to the longitudinal structural element 17, to allow, as known in the art, the passage of tools.

The working unit 14 according to this example comprises an electrospindle 30 which is of the dual output type, with a first output for a blade, 31, and a second output 31a for a milling cutter. However, instead of said dual output electrospindle, it is also possible to provide a single output electrospindle. The electrospindle 30 is carried by a carriage 32 translatable along a second Y direction on corresponding rails 33 above the central frame 13, via a vertical arm 34 vertically translatable in a third Z direction.

In particular, the example of the state of the art illustrated, shows a working unit 14 that is translatable at least according to the two Y and Z directions, in this case, a horizontal y direction perpendicular to the supply direction of the pieces to be machined and a vertical Z direction, while said working unit and rotatable around said Z axis and the electrospindle 30 is in turn rotatable and orientable around the axis perpendicular to said Z axis.

A possible embodiment may provide that said working unit 14 is further translatable along the X axis parallel to the supply axis of the pieces being processed, thanks to a carriage structure supported on additional guides oriented in the direction of said X axis and on which in turn the guides 33 of the carriage 32 are mounted.

It is clear that in the illustrated form the working unit has at least four and optionally five axes of movement.

Regarding the electrospindle in particular to dual output and the automatic tool change organs, this type of electrospindle is known in the state of the art and examples of the same are described in the document IT102016000107750. In this example, the dual output spindle presents a circular saw blade stably fixed to an output, while the opposite output provides a mandrel for fixing a tool, in particular and preferably by automatic coupling and decoupling thanks to automatic organs that can be realized according to the example described in the aforementioned document.

As is evident from FIG. 13 relating to the known state of the art, the machining unit configured with the five axes of movement allows performing a considerable number of beam machining operations; however, machining operations using milling tools on the side of the piece being processed facing the support plane defined by said conveyors are precluded.

IT1270691 of the same applicant relates to a machine of the aforementioned type. In the machine according to the document described, the work plan on which the piece is placed comprises at least two cross members movable in a direction perpendicular to their longitudinal extension and parallel to each other along a translation guide, which guide extends along a path that passes in correspondence of a machining station. In the machining station, there is provided a machining head that can move and orient in space according to different directions of translation and/or rotation. On each cross member are mounted one or more piece holding heads that include retaining organs cooperating with the piece and that in the illustrated embodiment are of the suction type, i.e., suction cup. Said heads are movable along the corresponding cross member in the longitudinal direction of the same and in particular in a direction perpendicular to the direction of movement of the cross members.

As is evident, the configuration of this machine provides at least one working head that can perform operations only on the faces of the piece to be machined not facing the cross members, i.e., not facing the work plan.

Therefore, the aforementioned document shows conveyors that consist of a plurality of support cross members for said piece that are distributed side by side along said path and that are oriented transversely to said supply direction of the piece and are positioned or positionable each at a predetermined distance from adjacent cross members;
said cross members being movable together or separately from each other along guides that extend parallel to said supply direction thanks to actuators for moving them;
each cross member or some of said cross members being provided with support surfaces for the or the pieces being processed;
each cross member being provided with at least one positioning stop and/or piece retention organs with respect to the longitudinal extension of the cross member, which stop and/or which retention organs are movable respectively to the active interference position and/or blocking of the piece and in an inactive position of interference and/or blocking of said piece;
a control unit being provided that executes a control program in which the instructions are encoded for controlling in a mutually synchronized manner at least said translation and/or rotation organs motorized associated with said at least one working head, each of said actuators for moving said cross members, and/or the positioning stops and/or the retention organs of the pieces on the cross members.

The present invention aims to create a machine of the aforementioned type that overcomes the inconveniences of known machines and allows machining of the piece both on the sides freely exposed i.e., not facing the conveyor, and machining on or the sides in contact with the conveyor all without requiring actions of overturning the piece to bring in exposed and freely accessible conditions the sides facing or resting on said cross members.

Furthermore, the present invention aims to achieve the aforementioned functionalities in a constructively, relatively simple and inexpensive manner as well as quickly and efficiently as possible without requiring complex piece positioning operations and without requiring downtime of the machining processes.

The present invention solves the problem posed with a machining center, particularly for pieces to be machined such as beams, boards, or the like, which includes:
a portal, optionally of the stationary type, presenting a passage opening for a piece to be machined, such as a beam to be machined, or the like;
supply members for said piece to be machined, along a straight supply path of said piece to be machined, which path is oriented according to a first axis of translation (X) and insertion of said piece through said passage opening;
a working unit comprising an electrospindle for coupling and operating at least one working tool;
said working unit being supported by first and second linear translation members of the same according to at least a first and a second direction of translation, respectively, which first and second directions of translation are perpendicular to said supply direction of the piece to be machined and being also rotatable around at least two rotation axes perpendicular to each other,
characterized in that
said working unit is carried by a further third linear translation member, which third member is interposed between said working unit and said first and second linear translation members and which said third translation member is rotatable with respect to said first and second translation members around two axes perpendicular to each other, of which a first axis of rotation is perpendicular to said supply direction of the piece to be machined and to a second axis of rotation;
and of which said second axis of rotation is perpendicular to said first axis of rotation and parallel to said plane containing said supply direction and perpendicular to said first and second directions of translation,
while said third translation member has a translation direction of the working unit that is perpendicular to said first and to said second axis of rotation of said third translation member and one of said rotation axes of the working unit is parallel to said translation direction of said third translation member.

A preferred embodiment provides a machining center of said type, where said translation directions respectively of the first, second, and third translation members are all perpendicular to the supply direction of the piece to be machined.

In one embodiment, the linear translation direction defined by said first translation member is the vertical direction or a direction that has a predominant directional component in the vertical direction; the supply direction of the piece to be machined being oriented perpendicularly to said first linear translation direction;
said second linear translation direction of said second linear translation member is perpendicular to said first linear translation direction and to said supply direction of the piece to be machined;
while said third linear translation member is supported by the combination of said first and said second translation member and is rotatable around said first axis of rotation which is parallel to said first direction of translation and to said second axis of rotation which is perpendicular to said first axis of rotation,
and while the third direction of translation determined by said third linear translation member is perpendicular to said first axis of rotation of said third translation member and parallel to a plane in turn parallel to said supply direction to the linear translation direction of said second translation member,
said working unit being rotatable around a rotation axis parallel to the translation direction defined by said third linear translation member and around a rotation axis perpendicular to the latter.

Another further embodiment provides that said translation direction of the first translation member is the vertical direction, the supply direction of the piece to be machined is a horizontal direction and the translation direction of the second linear translation member is a horizontal direction and perpendicular to said supply direction of the piece, the third direction of translation being orientable at will within a vertical plane, i.e., perpendicular to the horizontal plane.

In one embodiment, the machining center according to any one of the preceding embodiments comprises, in combination with said portal, a supply conveyor of at least one piece to be machined or a succession of pieces to be machined along a path that extends from a loading station of or the said pieces to be machined, through or in correspondence with said portal and up to a unloading station of said pieces, after machining in said portal.

According to an embodiment, said conveyor includes a plurality of transport members of the said piece(s) to be machined, consisting of a plurality of support cross members of said piece that are distributed side by side along said path and that are oriented transversely to the supply direction of the piece or pieces to be machined along said path and are positioned or positionable each at a predetermined distance from adjacent cross members;
said cross members being movable together or separately from each other along guides that extend parallel to said path thanks to actuators for moving them;
each cross member or some of said cross members being provided with support surfaces for the piece(s) being processed;
each cross member being provided with at least one positioning stop and/or piece retention organs with respect to the longitudinal extension of the cross member, which stop and/or which retention organs are movable respectively to the active interference position and/or blocking of the piece and in an inactive position of interference and/or blocking of said piece;
a control unit being provided that executes a control program in which the instructions are encoded for controlling in a mutually synchronized manner at least said translation and/or rotation organs of the working unit and the third translation member, each of said actuators for moving said cross members, and/or the positioning stops and/or the retention organs of the pieces on the cross members.

A constructional variant of the machining center and in particular of the fixed portal of the same provides:
a first support column oriented substantially vertically and which support column is mounted sliding in a vertical direction in a corresponding vertical guide,
said vertical guide being mounted, in turn, on a carriage which is mounted sliding on a horizontal guide,
in said first column being supported a vertical rotation spindle, whose axis of rotation is parallel or coaxial to the axis of said first column or said first column being itself rotatable around its longitudinal vertical axis,
to said first column or to said vertical rotation spindle is fixed a support element of a further translation guide for a second translation column,
said further translation guide being supported by said support element in a rotatable manner around a rotation axis which is perpendicular to the axis of the vertical rotation spindle of said first column;
in said second column being supported a rotation spindle, whose axis of rotation is parallel or coaxial to the axis of said second column or said second column being itself rotatable around its own longitudinal axis,
to said second column or to said rotation spindle of said second column is fixed a support bracket of the working unit which is integral at least in translation with said second column and is rotatable together with said second column or with the rotation spindle present in the same,
the electrospindle of the working unit being fixed to said bracket in an oscillating manner around an oscillation axis perpendicular to the axis of said second column and/or to the rotation spindle associated with the same;
the vertical translation of said first and that of said second column and/or the rotation of said first or of said second column around their longitudinal axis or of the corresponding rotation spindle, the translation of the support carriage of the vertical guide of said first column and/or the rotation of the translation guide of the second column with respect to the fixing element to the first column or to the rotation spindle mounted in the same and the oscillation of the electrospindle with respect to the bracket being controlled independently of each other by actuation motors each controlled by said control unit that executes said control program in which the instructions for controlling in synchronized manner at least said translation and/or rotation organs of the working unit and of the third translation member, each of said actuators for moving said cross members, and/or the positioning stops and/or the piece retention members on the cross members are coded.

The various translation organs, rotation supports, motorized actuators for performing linear or angular movements, conveyors, the control unit, and other constructive parts can be made in any way also using constructive forms similar to those described in the documents mentioned above.

For example, in a possible embodiment the electrospindle can be realized according to the document IT102016000107750 or IT102011901997732 which are integrated by reference in this description.

As for the loading and unloading conveyors, these can be made up of a series of cross members that are movable along the transverse axis (y) to the portal and that support the piece to be machined, forming the so-called work plan.

The piece can be loaded onto two or more of said cross members with an automatic or manual system. The precise reference position of the piece is defined by the stops of the cross members themselves that define a precise lower support plane and are provided with lateral stops having a predetermined position with respect to the cross members and to the portal, i.e., to the working unit.

According to a preferred embodiment, the cross members are provided with retention organs of the or the pieces to be machined, which lock the piece or pieces in a removable way.

Embodiments of said removable retention organs can be constituted alternatively or in combination by retention organs that operate a mechanical fixation and/or by suction cups.

The cross members are thus controlled to grasp each piece to be machined in a predetermined position and to bring the piece in correspondence of the working unit by their translation along the path defined by the guides for the same.

The command of the movement of the cross members by the control unit can provide that the cross members are positioned and repositioned appropriately on the piece to be able to work it anywhere on its surfaces.

The portal may also be associated with a plurality of working units, each with at least one electrospindle having a single output axis or two output axes, while the two or more working units are supported by a combination of translation and rotation organs according to one or more axes similarly to what is defined above and this for each working unit or only for one or some. Again according to an embodiment, the portal can be associated with at least one automatic tool changing system that includes a warehouse for the automatic deposition of tools and for the automatic withdrawal of tools by the electrospindle itself.

Furthermore, the portal can provide different configurations of the working units:

According to a first example the working unit is single-headed, i.e., it provides a single electrospindle at one end of the third column;

According to an embodiment, the column constituting the third translation member can carry two electrospindles each respectively on one of the two opposite ends of said column;

According to a third embodiment at one end of the column of the third translation member is provided an electrospindle, while at the opposite end to the column is associated a cutting tool, like a circular blade with the corresponding rotation drive motor.

In all cases, the or the electrospindles can be at least partly of the type suitable for performing an automatic tool change, or it is possible that one or more of said electrospindles are stably coupled with its tool. The tools can be of any type with rotation drive, such as milling cutters, drilling bits or other tools.

Further features are the object of the dependent claims.

From the above and the following description, the advantages of the present invention will be clearly shown.

These and other features and advantages of the present invention will become clearer from the following description of some embodiments illustrated in the attached drawings wherein:

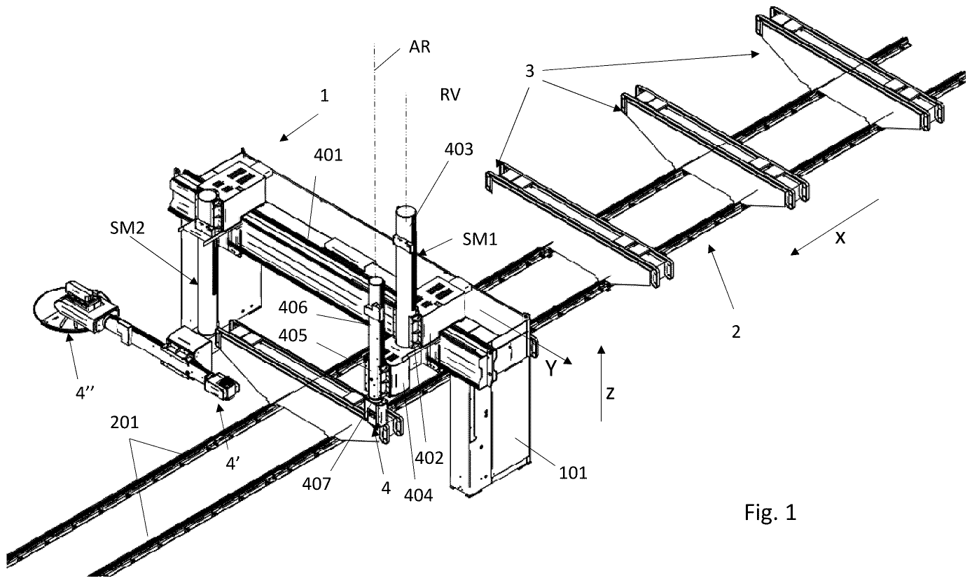

FIG. 1 shows a view of an example of a machining center according to an embodiment provided in the state of the art.

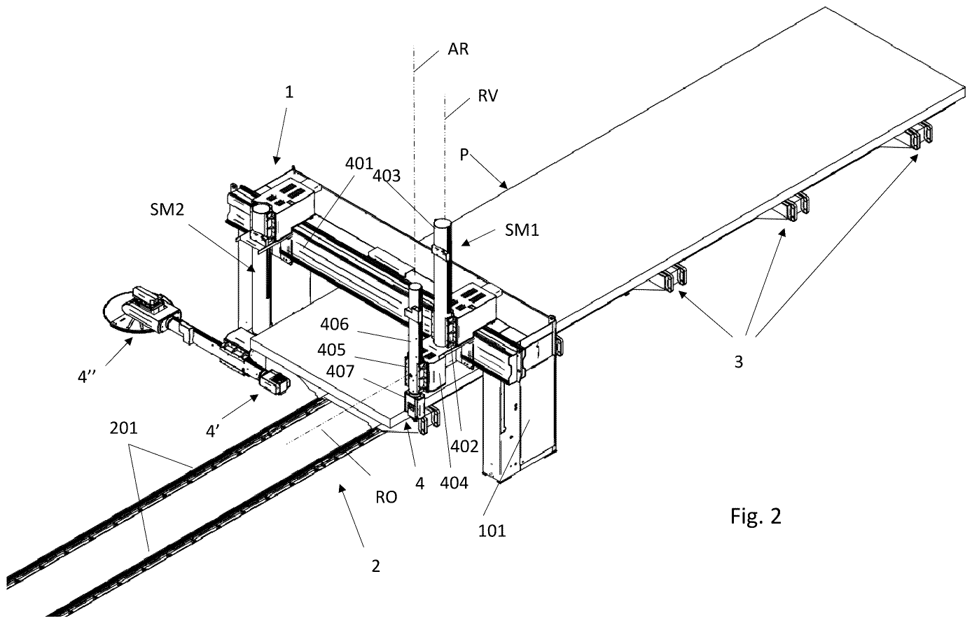

FIG. 2 shows an overall perspective view of a machining center according to an embodiment of the present invention.

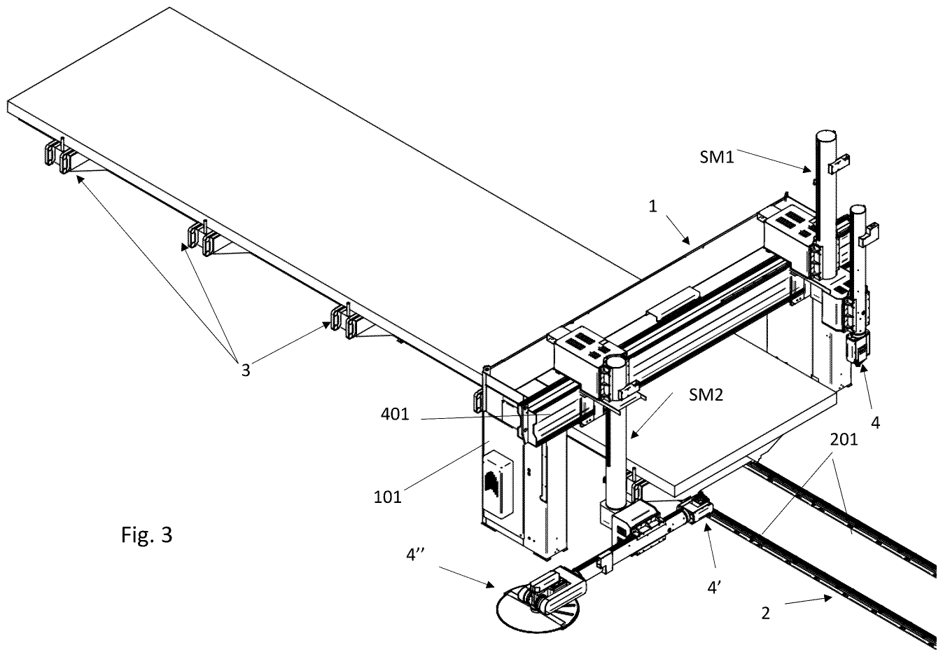

FIGS. 2 and 3 show two perspective views of the machining center according to FIG. 1 according to two opposite viewing directions and with a piece to be machined mounted on the unloading conveyor.

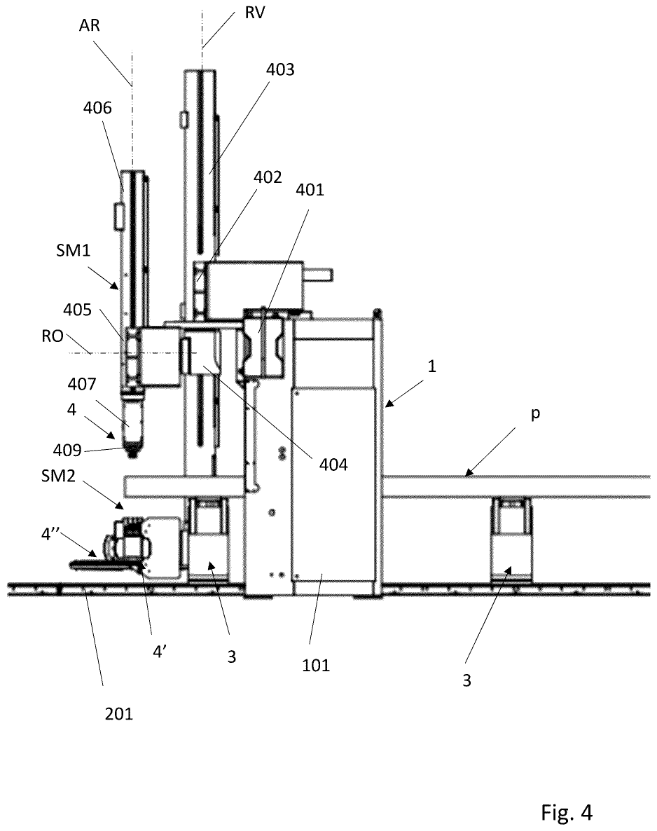

FIG. 4 shows a side elevation view according to a direction perpendicular to the supply direction of the pieces being processed.

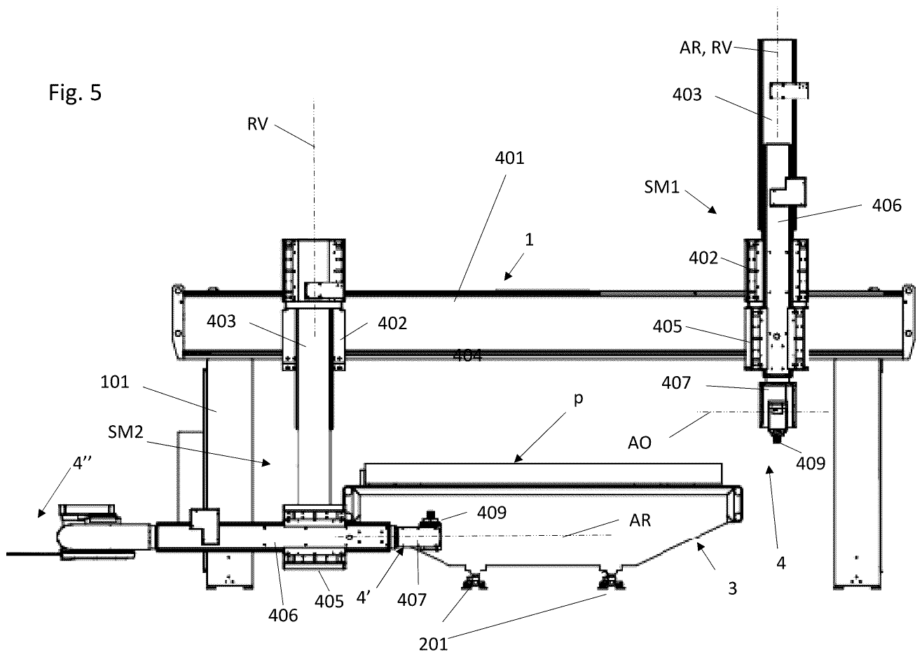

FIG. 5 is a view of the machining center according to the previous FIGS. 1 to 4 according to a viewing direction parallel to the supply direction of the pieces to be machined.

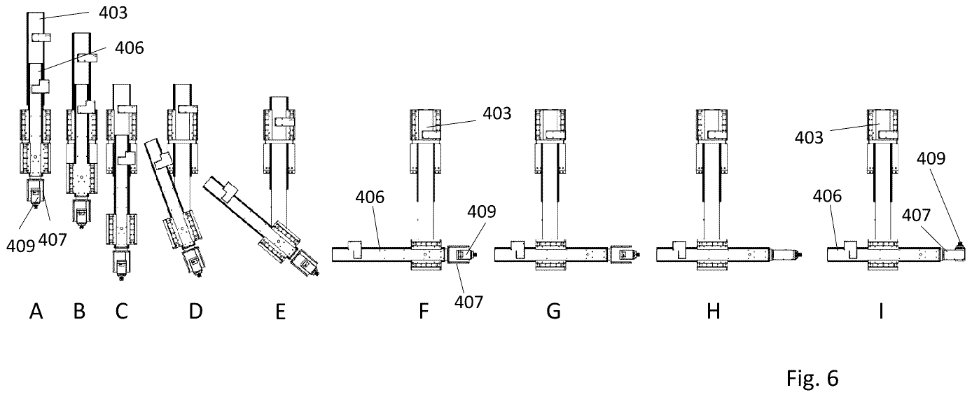

FIGS. 6A, 6B, 6C, 6D, 6E, 6F, 6G, 6H, 6I show different phases of movement of the working unit performed with the machining center of the present invention.

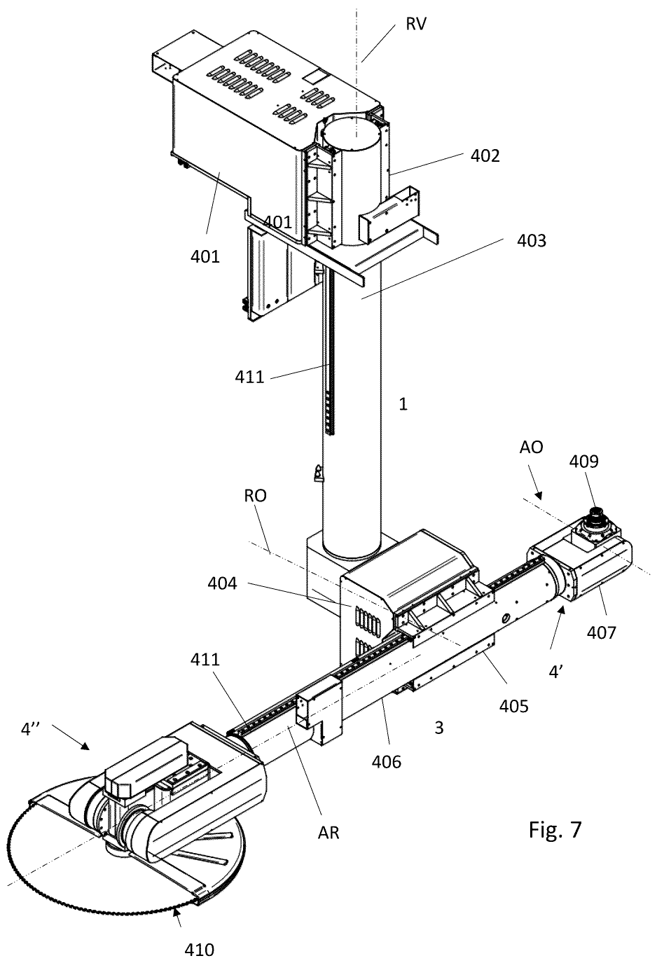

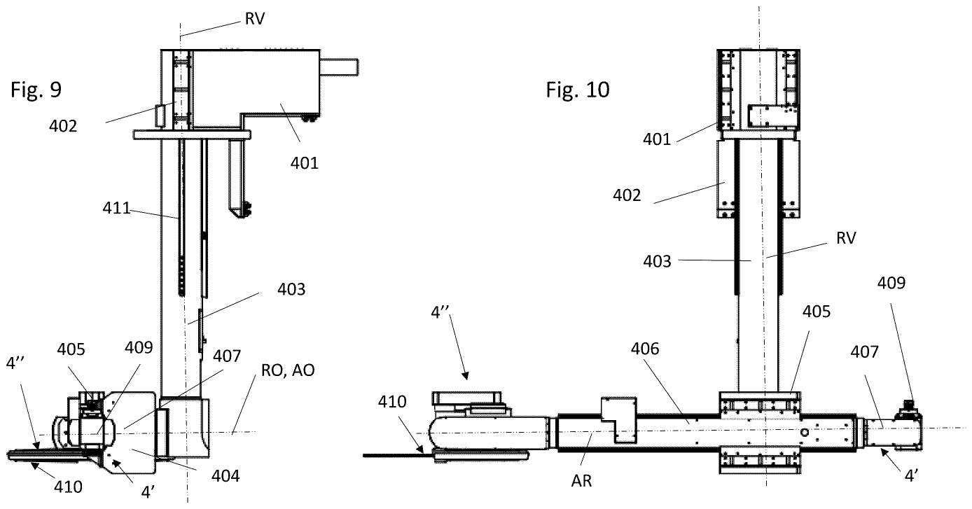

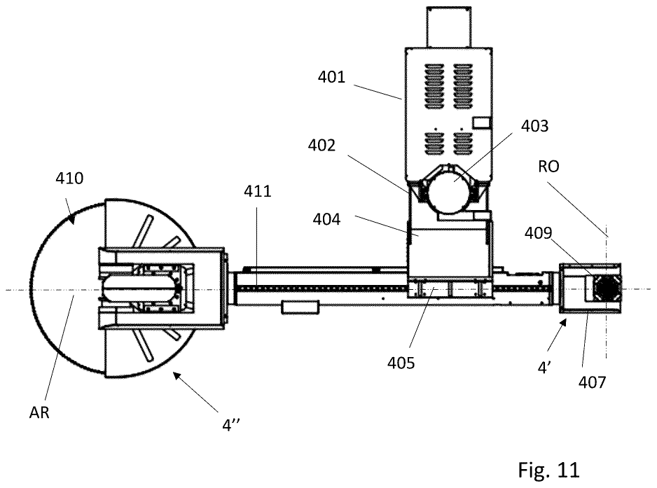

FIGS. 7 to 11 show different views of a working unit according to an embodiment of the present invention wherein the movement system according to three axes of translation and four axes of rotation carries two working heads of which one is constituted by an electrospindle and one is constituted by a circular cutting blade.

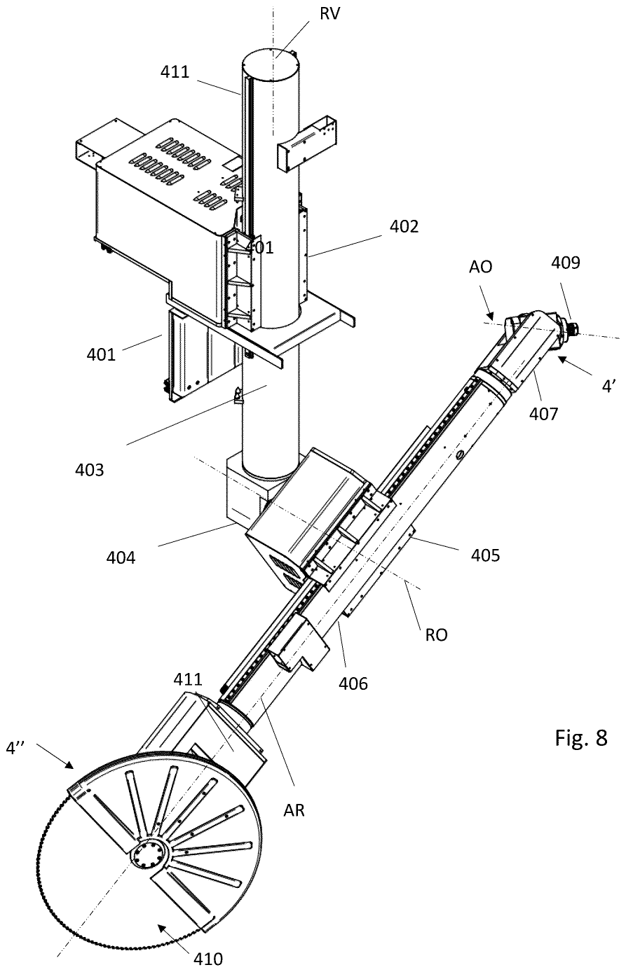

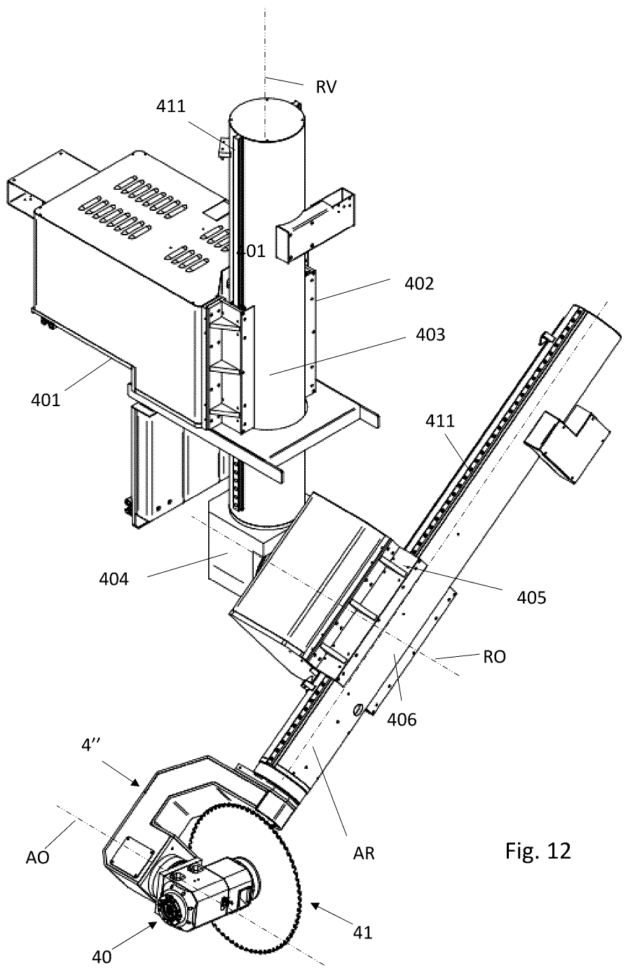

FIG. 12 shows similarly to FIG. 8 an embodiment of the working unit 4″, which is realized according to what is described in the document EP2799174.

FIG. 13 shows a view of an example of a machining center according to an embodiment provided in the state of the art.

With reference to FIGS. 1 to 5, a machining center according to an embodiment of the present invention includes a conveyor 2, specifically horizontal which in turn is constituted by a pair of guides 201 parallel to each other and oriented in the supply direction of a piece to be machined P. The conveyor passes in correspondence of a machining portal 1.

In the illustrated embodiment, said portal 1 is provided at a midpoint of the longitudinal extension of the conveyor 2 in the supply direction of the piece and defines a loading end of the piece and supply to the portal and an opposite unloading end of the piece P.

The conveyor according to the illustrated embodiment is constituted by a plurality of cross members 3 that are oriented perpendicularly to the supply direction of the piece P towards and through the portal 1, i.e., to the guides 201 and that are engaged sliding on said guides 201.

The cross members are translatable along the guides 201 by means of motorized actuators.

It is possible to provide a single motorized actuator for all the cross members or for some groups constituted by only some of the cross members, or it is possible to provide a separate and independent motorized translation actuator for each or at least some of the cross members 3.

For example, to the pairs of guides can be associated one or more racks with which a pinion of a respective motorized translation actuator fixed to the cross member in one or two points spaced from each other of the cross member engages. A possible embodiment may provide a rack stably fixed to one or both guides and a motor with a pinion positioned on each cross member in such a position of the same to engage with one of the racks. Each motor of each motorized actuator is controlled by a control unit that executes a control program to translate the piece being machined according to advancement steps compatible with the expected machining operations.

The motorized translation actuator or the motorized translation actuators of the cross members 3 are commanded by a control unit (not illustrated in detail), which can be part of a control station that is provided, for example, in the structure of the portal 1. For example, the control unit can be in the form of a processor, like a PLC or similar that executes a control software. In this case, the control software includes among other things also the instructions to command the activation or the stop of the or the translation actuators of the cross members 3 in a manner synchronized with the other functions of the machining process as will appear more clearly later. When for example each cross member or only some of the cross members or different groups of cross members are provided with a separate and dedicated motorized translation actuator, then the control software executed by the control unit further includes the instructions to synchronize among them said cross members and/or said groups of cross members to perform relative movements between at least one of the cross members with respect to one or more of the other cross members or between a group of cross members with respect to one or more of the other cross members or other groups of cross members or to perform movements together of all or part of the cross members without between these occurring relative movements.

The machining portal 1 can be made in any way and in the present example presents an upper horizontal guide 401, provided at a predetermined distance from the support plane of the piece P constituted by upper support surfaces of the individual cross members 3.

Along the upper horizontal guide 401 moves, on a carriage or a sliding sled along said horizontal guide 401, a vertical translation guide 402. of an upper working head 4, i.e., a working head that performs machining of the or by the sides of the piece being processed that are oriented opposite the cross members 3 and/or at least with a directional component perpendicular to the work plan or to the support surfaces of the piece P of the cross members 3.

In the vertical guide 402 is mounted sliding a vertical column 403, i.e., a column whose longitudinal axis is vertical. Said vertical column 403 carries at its lower end a rotating support 404 which support 404 is carried by the vertical column 403 in a rotatable manner around a vertical rotation axis, optionally coinciding with the axis of the column 403 as shown with the axis indicated with RV and moreover to said rotating support 404 is fixed in a rotatable manner around a horizontal axis and perpendicular to the vertical axis a sliding guide 405 for a further column 406 that is axially translatable, said rotation axis being indicated with RO.

The column 406 constitutes a third translation member of the working unit indicated with 4 and which includes a U-shaped bracket 407 fixed to the end of the column 406 and which bracket 407 carries in an oscillating manner around an oscillation axis AO of an electrospindle 409 which oscillation axis AO is perpendicular to the longitudinal axis of said second column 406. Furthermore, the U-shaped terminal bracket 407 is fixed to the column 406 in a rotatable manner around a rotation axis parallel or also optionally coinciding with the longitudinal axis of said column 406 and indicated with AR.

Although not illustrated in detail, each movement of translation and/or rotation of the elements that constitute the support system of the working unit 4 is commanded by motorized actuators, not illustrated in detail.

The synchronized command of the individual motorized actuators takes place thanks to a control station appropriately configured to operate said motorized actuators of the movement system of the operational unit in sync with the command of the motorized actuators of translation of the cross members 3.

The control station may include a computerized control unit, i.e., provided with a CPU that executes a control program in which are coded the instructions to command in a synchronized manner the aforementioned motorized actuators to obtain an advancement of the piece to be machined relatively to the portal and a movement in space of the working unit corresponding to the desired machining.

In the illustrated figures, the portal is provided with more working units that are respectively carried by two movement systems indicated with SM1 and SM2 in the figure.

The particular configuration of the SM2 system will be described with more detail following.

FIGS. 6A to 6I show different discrete positioning steps of the working unit 4, i.e., the electrospindle that allow bringing said operational unit to work the piece P also from the lower side of the same, i.e., from the side facing the work plan, or the cross members 3.

The initial position 6A corresponds to that illustrated in FIGS. 1 to 5 and in which the working unit, or in this case a milling cutter mounted on the electrospindle 409, is in a position such that it can operate on the upper side of the piece P and possibly on the lateral surfaces or the lateral edges. The column 406 is in a position parallel to the vertical column 403. One or both of the columns 403, 406 are translated downwards as illustrated in FIGS. 6B and 6C. upon reaching the lowest translation position, the column 406 is progressively rotated from the vertical position to the horizontal one around the axis AO and until assuming the horizontal position as shown by the sequence of FIGS. 6D to 6F. FIG. 6G shows the translation of the column 406 in the direction of its longitudinal axis for the positioning of the working unit 4 with respect to the piece P (not illustrated).

At step 6H, the column 406 together with the bracket 407 or only the bracket 407 with respect to the column 406 are rotated around the axis AR to bring the oscillation axis of the working unit 4 into the horizontal position in which said working unit can be oscillated upwards with the working tool oriented in working position against the surface of the lower side of the piece p, as shown in FIG. 6I.

In FIGS. 6A to 6I a possible rotation of yaw of the column 406 thanks to a rotation of the same around the longitudinal axis, vertical of the column 403 is not shown. FIGS. 7 to 11 show different views of the SM2 movement system according to the left embodiment of FIGS. 1 to 5. In this embodiment, the difference with respect to the right variant described in detail above of the movement system of the operational unit 4 indicated with SM1, consists in the fact that the column 406 carries a working unit on each of its ends. In the figures, these working units are indicated with 4′ and 4″. The working unit 4′ is substantially identical to the working unit 4, while the working unit 4″ consists of a rotating cutting blade mounted on a rotation drive motor globally indicated with 410.

In the embodiment of FIGS. 7 to 11, the rotating cutting blade of the unit 4″ is stably coupled to the column 406 and is not replaceable or interchangeable with other operational units. However, it is possible to provide embodiments where also the working unit 4″ is of the type constituted by an electrospindle to which is alternately couplable a tool selectable among a series of different machining tools.

From the figures, it is evident how thanks to the translations of the columns 403 and 406 parallel to their longitudinal axes and to the horizontal translation in the direction perpendicular to the advancement of the piece to be machined P and thanks to the rotations and oscillations with respect to the axes RV, RO, AO, AR above defined it is possible to bring to operate on the piece alternately between them and with various inclinations and along various paths the working tool 4′ or the working tool 4″ and this both on the upper side and the lateral edges and on the lower side of the piece P to be machined.

The solutions of the illustrated embodiments are to be considered only illustrative in order to make evident executive modalities of the present invention of the more general technical teaching.

Alternative solutions are within the reach of the technician of the field and of his basic technical knowledge and are clear once shown the illustrative solutions of the illustrated and described embodiments.

Thus, for example, from FIGS. 7 to 11 results a form of implementation of the axial translation of the columns 403 and 406 which provides a rack 411 engaged with a pinion in the sliding guide respectively 401 and 405.

As for the rotation around a vertical axis RV and to the axis of the column 406 AR, the column 403 and/or 406 is constituted by a cylindrical tubular sleeve that carries the rack 411 and in which is coaxially mounted a further cylindrical element that is rotatable with respect to said outer sleeve. The rotation can be actuated for example by an electric cylindrical motor or in another way.

With reference to FIG. 12, the working unit 4″ is realized according to an embodiment that provides a dual output electrospindle that includes an electric motor, whose shaft is rotationally couplable with a milling tool indicated with 40 at one end, while the opposite end drives in rotation a blade of a circular saw indicated with 41. The dual output electrospindle is mounted rotatable around an axis perpendicular to the axis of the motor shaft of the same, to an angled support head 42, which in turn rotates around the axis AR. A detailed example of this type of dual output spindle is described in the document EP2799174 A1.

This embodiment allows having even more degrees of freedom and to provide two milling heads respectively on one of the two ends of the column 406, one of which is provided replaceable with the circular saw 41.

The invention claimed is:

1. A machining center comprising:
a portal (1) having an opening for a passage of a piece;
supply members (2, 3) for said piece to be machined, said supply members being arranged along a rectilinear supply path of said piece to be worked, said path being oriented according to a first axis of translation (X) and insertion of said piece through said opening;
a work unit (4, 4′, 4″) comprising an electrospindle (409) for coupling to and operating a work tool;
wherein said work unit (4, 4′, 4″) is supported by first and second linear translation members (401, 403) according to a first and a second translation direction (y, z), said first and said second translation directions being perpendicular to a supply direction (x) and being further rotatable around at least two rotation axes (AO, AR) perpendicular to each other; and
wherein said work unit is further carried by a third linear translation member (406), said third translation member (406) being interposed between said work unit (4, 4′, 4″) and said first and said second linear translation member (401, 403), said third translation member (406) being rotatable with respect to said first and said second translation members (401, 403) around two perpendicular axes, of which:
a first axis of rotation (RV) is perpendicular to said supply direction (x) of the piece to be machined (P) and to a second axis of rotation (RO),
said second axis of rotation (RO) is perpendicular to said first axis of rotation (RV) and parallel to a plane containing said supply direction (x) and perpendicular to said first and said second translation directions (y, z),
said third translation member (406) has a translational direction of the work unit which is perpendicular to said first (RV) and said second (RO) axis of rotation of said third translation member (406) and one of said first and said second axes of rotation of the work unit (AR) is parallel to said translational direction of said third translation member (406).

2. The machining center according to claim 1, wherein said first and said second translation directions (y, z) respectively of the first and second translation member (401, 403) are all perpendicular to the supply direction (x) of the piece to be machined, and wherein the direction of translation of the third translation member (406) is contained in a vertical plane, parallel to the direction of translation (y) of the first translation member (401).

3. The machining center according to claim 1, wherein:
the second translation direction (z) defined by said first translation member (403) is a vertical direction or a direction which has a predominant directional component in the vertical direction;
the supply direction (x) of the piece to be machined (p) is oriented perpendicular to said second translation direction (z);
said first translation direction (y) of said second linear translation member (401) is perpendicular to said second translation direction (z) and to said supply direction (x) of the piece (p) to be machined;
wherein said third linear translation member (406) is supported by a combination of said first and said second translation member (401, 403) and is rotatable around said first axis of rotation (RV), which is parallel to said first direction of translation (z) and to said second axis of rotation (RO), which is perpendicular to said first axis of rotation (RV);
wherein the third direction of translation determined by said third linear translation member (406) is perpendicular to said first axis of rotation (RV) of said third translation member and parallel to a plane that is parallel to said supply direction (x) to the translation direction of said second translation member (401), and
wherein said work unit (4, 4′, 4″) is rotatable about an axis of rotation (AR) parallel to the translational direction of said third linear translation member (406) and around an axis of rotation (AO) perpendicular to the translational direction of said third linear translation member (406).

4. The machining center according to claim 3, wherein said second translation direction (z) of the first translation member (403) is vertical-direction, the supply direction (x) of the piece (p) is horizontal and the first translation direction (y) of the second translation member (401) is horizontal and perpendicular to said supply direction (x) of the piece (p), the third direction of translation being orientable at will inside a vertical plane.

5. The machining center according to claim 3,
further comprising, in combination with said portal (1), a feed conveyor (2, 3) for one or more pieces (p) along a path, which extends from a loading station of the said one or more pieces (p), through or in correspondence with the portal (1) and up to an unloading station of the said one or more pieces (p), after processing in said portal (1),
said conveyor (2, 3) comprising a plurality of transport members (3) of the one or more pieces (p), having a plurality of support crosspieces of the one or more pieces (p) which are distributed side by side along said path (2) and which are oriented transversally to the supply direction (x) of the one or more pieces to be machined (p) along said path and are each positioned or positionable at a predetermined distance from adjacent crosspieces,
said crosspieces being displaceable together or separately from each other along guides (201) which extend parallel to said path due to actuators for displacing said crosspieces,
each crosspiece or some of said crosspieces being provided with support surfaces for the one or more pieces being processed (p),
each crosspiece (3) being provided with at least one positioning abutment and/or workpiece retention members with respect to a longitudinal extension of the crosspiece, said abutment and/or said retention members being movable respectively to an active interference position and/or or blocking of the piece and in an inactive position of interference and/or blocking of said piece; and
a control unit which executes a control program, in which instructions are encoded for controlling in a mutually synchronized way at least said first, second, and third translation and/or rotation members of the machining center and of the third translation member, each of said actuators for moving said crosspieces, positioning stops, and/or elements for retaining the one or more pieces on the crosspieces.

6. The machining center according to claim 5, further comprising:
a first support column (403), which is oriented substantially vertically and which is slidably mounted in a vertical direction in a corresponding vertical guide (402),
said vertical guide (402) being mounted on a carriage (401), which is slidably mounted on a horizontal guide,
a vertical rotation shaft supported in said first support column (403), an axis of rotation (RV) of said vertical rotation shaft being parallel or coaxial to an axis of said first support column (403) or said first support column (403) being rotatable around a longitudinal vertical axis thereof,
a support element (404) of an additional translation guide (405) for a second translation column (406), said support element being fixed to said first column (403) or to said vertical rotation shaft,
said additional translation guide (405) being supported by said support element (404) in a rotatable manner around an axis of rotation (RO), which is perpendicular to an axis of vertical rotation shaft of said first support column (403),
wherein a rotation shaft is supported in said second translation column (406), an axis of rotation of said rotation shaft (AR) is being parallel or coaxial to an axis of said second translation column (406) or said second translation column (406) being rotatable around a longitudinal axis thereof,
wherein a support bracket (407) of the control unit is fixed to said second column (406) or to said rotation shaft of said second column (406), said control unit being fixed at least in translation to said second column (406) and being rotatable together with said second column (406) or with the rotation shaft present in the second column,
wherein the electrospindle (409) of the work unit (4, 4′, 4″) is fixed to said support bracket (407) in an oscillating manner about an oscillation axis (AO) perpendicular to the axis of said second column (406) and/or to the rotation shaft associated therewith, and
wherein the vertical translation of said first (403) and that of said second column (406) and/or the rotation of said first or of said second column (403, 406) around longitudinal axes thereof (RV, AR) or of a corresponding rotation shaft, the translation of the carriage (401) of the vertical guide (402) of said first column (403) and/or the rotation of the translation guide (405) of the second column (406) with respect to the element (404) to the first column (403) or to the rotation shaft mounted therein and the oscillation of the electrospindle (409) with respect to the support bracket (407) are controlled independently of each other by actuation motors each controlled by the control unit, which executes said control program in containing the instructions for controlling at least said translation (401, 402, 403) and/or rotation members of the work unit (4, 4′) in a mutually synchronized manner, 4″) and of the third translation member (405, 406), each of said actuators for moving said crosspieces (3), positioning strikers, and/or the workpiece retention members on the crosspieces (3).

7. The machining center according to claim 6, wherein the work unit comprises a double output electrospindle having a motorized drive shaft, to whose two opposite ends a tool can be coupled, said tool being selected from a plurality of different tools interchangeable with each other, or one of said ends of the motorized drive shaft being stably and dynamically coupled to a rotating blade.

8. The machining center according to claim 6, wherein the support bracket has an angled shape with two branches oriented transversally to each other, one of said two branches being fixed to the third translation member (406) and the other branch of said two branches of the electrospindle being rotatable around an axis parallel to the longitudinal axis of the third translation member (406) and being the electrospindle (409) rotating around a longitudinal axis of said other branch of the support bracket.
